(19) United States
(12) Patent Application Publication
(10) Pub. No.: US 2006/0066075 A1
(43) Pub. Date: Mar. 30, 2006

(54) Towing trailer for two or three wheeled vehicles

(76) Inventor: Kevin J. Zlotkowski, Aliso Viejo, CA (US)

Correspondence Address: Harold L. Jackson;Jackson Law Corporation, 14751 Plaza Dr., Ste. N, Tustin, CA, 92780, US

(21) Appl. No.: 10/951,965

(22) Filed: Sep. 28, 2004

(51) Int. Cl. B60P 3/06; B60F 1/00; B62D 53/04

(52) U.S. Cl. 280/402

(57) ABSTRACT

A bicycle trailer includes a frame forming an elongated cradle or wheel well for receiving and supporting the front wheel of a towed bicycle above the ground. At least one, and preferably two, wheels are mounted on the frame and a tow bar extends forwardly of the cradle for connection to a towing bicycle.

### FIELD OF THE INVENTION

The present invention relates to a towing apparatus for towing a wheeled vehicle behind another and especially to a trailer for towing one bicycle behind another.

### BACKGROUND OF THE INVENTION

Bicycling is becoming more and more of a family sport with relatively young children riding their own bicycles while accompanying their parents on designated bicycle lanes on streets or on bicycle trails. It is common for young children to tire before the grown-ups tire. As a result it is necessary to plan relatively short trips or provide some means to reduce the exertion required by a child during longer trips. To this end, several devices have been proposed to allow a child's bicycle to be towed behind an adult's bicycle. See, for example, U.S. Pat. Nos. 4,261,592; 5,749,592; and 6,050,580 which disclose the use of tow bars connected between the towed and towing vehicles. Such tow bars are designed to be connected between the bicycles before the ride begins and would be awkward to carry and install midway through a ride. In addition, some of the tow bar arrangements would not relieve the child in the towed bicycle from the task of steering his or her cycle. U.S. Pat. No. 6,155,582 discloses the use of a more rigid towing bar arrangement which lifts the front wheel of the towed bicycle off of the ground. Again, this arrangement does not readily lend itself to installation while on the road.

U.S. Pat. No. 5,454,578 (“'578 patent”) describes a bicycle trailer for towing a child's bicycle in which the front fork of the towed bicycle is attached to a pair of towing bars with the front wheel of the towed bicycle engaging the ground. A pair of small outrigger wheels, in the form of training wheels, extend on either side of the front wheel of a towed bicycle for stability purposes.

While the '578 apparatus is designed to accommodate a tired child during a ride it requires modification of the front fork of the bicycle to be towed. In addition, the small outrigger wheels would provide considerable friction with or without the towed bicycle in place.

There is a need for a vehicle towing trailer which overcomes the above disadvantages.

### SUMMARY OF THE INVENTION

A bicycle trailer for supporting the front wheel of a towed bicycle, in accordance with the present invention, includes at least one, and preferably two, wheels and a frame defining a longitudinal axis supported at least in part by the wheel(s). The frame forms an elongated cradle or wheel well for receiving and supporting the front wheel of a towed bicycle above the ground. A tow bar extends forwardly from the cradle for connection to the towing bicycle. Preferably, the cradle includes at least two wheel engaging members for engaging and supporting the lower portion to the front wheel of a towed bicycle. The frame also preferably includes a pair of side support members carrying stub axles (on the two wheel arrangement) on which the trailer wheels are mounted for rotation about an axis perpendicularly oriented to the longitudinal axis. Stop members and vertically positioned stabilizer posts may be included in the frame to inhibit longitudinal and lateral movement of the towed bicycle, respectively, during a towing operation. The construction and features of the present invention may best be understood by reference to the following description taken in conjunction with the appended drawings where like components in the several figures are given the same reference numeral.

### BRIEF DESCRIPTION OF THE DRAWINGS

FIG. 1 is a side elevational view of a trailer in accordance with the present invention with the front wheel of a towed bicycle positioned within the frame's cradle and the tow bar attached to a towing bicycle;

FIG. 2 is a perspective view of the trailer of FIG. 1;

FIG. 3 is a side elevational view of the trailer with the trailer wheels mounted on the frame;

FIG. 4 is a side elevational view of the trailer with a front wheel of a towed bicycle secured in the cradle or wheel well and without the trailer wheels mounted on the frame for clarity;

FIG. 5 is a top plan view of the trailer with a front wheel of a towed bicycle positioned in the cradle;

FIG. 6 is a rear view of the trailer with a front wheel of a towed bicycle in place;

FIG. 7 is a front view of the trailer without a front wheel of a towed bicycle in place;

FIG. 8 is a perspective view of an alternative embodiment of the trailer showing a vertically adjustable lateral stabilizer bracket;

FIG. 9 is a side elevational view of the embodiment of FIG. 8 with a front wheel of a towed bicycle in place and without the trailer wheels;

FIG. 10 is a side elevational view of another embodiment of the trailer behind a towing bicycle;

FIG. 11 is a top plan view of the trailer of FIG. 10; and

FIGS. 12, 13 and 14 are side elevation, top plan and front views, respectively, of a further embodiment of a trailer in accordance with the present invention.

### DESCRIPTION OF THE PREFERRED EMBODIMENT

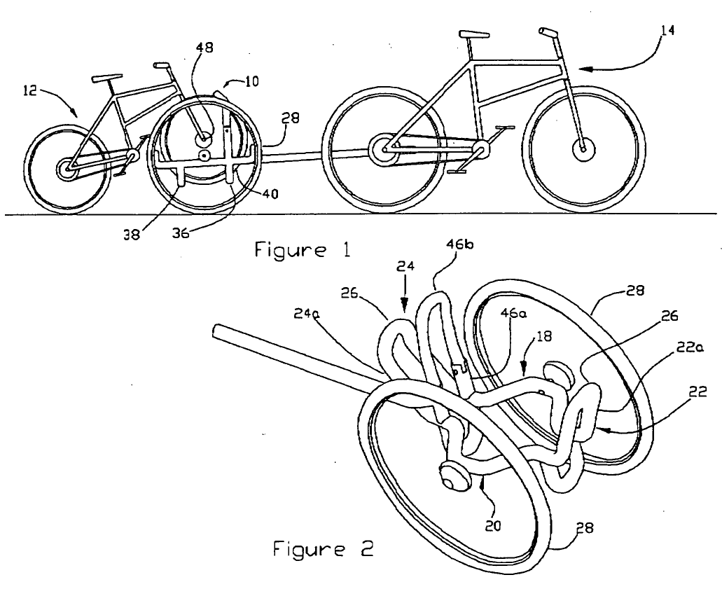

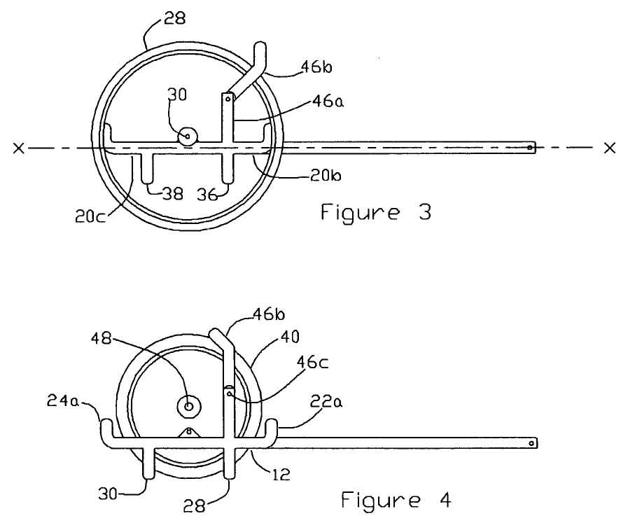

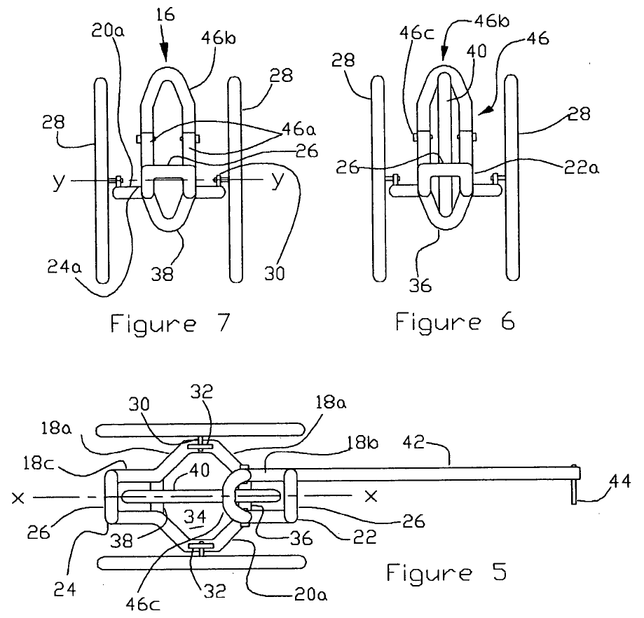

One preferred embodiment of a towing trailer 10, especially adapted to permit a child's bicycle 12 to be readily coupled to and towed by an adult's bicycle 14 during a ride without requiring any modification of the child's bicycle, is illustrated in FIGS. 1-7. The trailer frame 16, defining a longitudinal axis x-x, includes left and right side members 18 and 20 formed by generally arcuately shaped sections 18a and 20a merging into straight front (18b, 20b) and rear (18c, 20c) sections as shown in FIG. 5. Forward and rear inverted channel stop members 22 and 24 are joined to the ends of the straight side sections. As will be noted, the stop members are formed by upright portions 22a and 24a, respectively, and horizontal cross bars 26. The cross bars 26 serve to limit the forward and aft movement of the front wheel of a towed bicycle within the frame.

A pair of wheels 28, spaced, for example, about 12″ apart, are mounted on axle stubs 30 secured to respective side members 18 and 20 via brackets 32. The wheels rotate about an axis y-y perpendicularly oriented with respect to the longitudinal axis as shown in FIGS. 5 and 7.

The side frame members 18, 20 and the stop members 22, 24 define an interior opening 34 (FIG. 5) for accommodating the front wheel of a towed bicycle with a wheel support structure in the form of downwardly extending u-shaped wheel engaging members 36 and 38 extending between the left and right side sections and secured to or formed integrally therewith. The wheel engaging members are spaced along the longitudinal axis, fore and aft of the rotational axis y-y, of the trailer wheels 28 and together define a cradle or wheel well for supporting the lower portion of the front wheel 40 of a towed bicycle above the ground or support surface.

A tow bar 42 joined to the frame, i.e., to section 18a, extends forwardly for detachably connecting the trailer to a towing bicycle. While a single bolt/nut arrangement 44 is illustrated as the connecting system, any of several known connection systems may be used to secure the forward end of the tow bar to the towing bicycle.

For purposes of securing the front wheel 40 of a towed bicycle within the cradle or wheel well and for stabilizing the front wheel of a towed bicycle against lateral movement, an inverted u-bracket 46 is mounted or secured to the frame. The locking/stabilizing bracket 46 is formed of two lower fixed posts 46a which straddle the towed front wheel of a towed bicycle opening and extend upwardly from the one end of the side members, e.g., the front end as shown in the figures. Adjustable posts extend upwardly from the fixed posts to engage an upper portion of the front wheel of a towed bicycle. Preferably the upper posts include a cross bar to form an inverted u-shaped upper section 46b, the upper end of which extends above the anticipated axle 48 of a front wheel of a towed bicycle. As shown in FIGS. 1-7 the upper section 46b is pivotally mounted to the upper ends of the lower sections, e.g., with a conventional bolt/nut arrangement 46c to allow the insertion of a wheel to be towed into the cradle formed by the frame. The upper section 46b, when rotated against an upper portion of a front wheel of a towed bicycle, engages each side of the wheel as is illustrated in FIG. 6 so that the wheel can be locked in place by tightening the nuts.

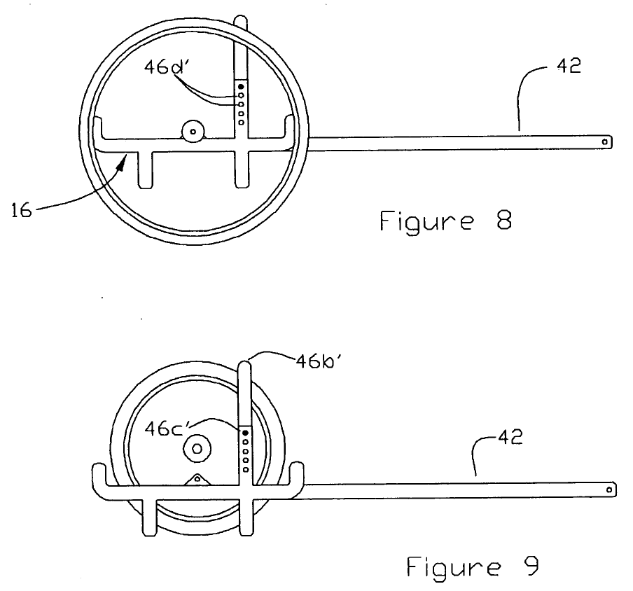

Referring now to FIGS. 8 and 9 an alternative locking/stabilizer bracket is illustrated in which the upper section 46b′ is telescoped into the fixed lower posts by spring biased pins or detents 46c′ which selectively extend through openings 46d′. The upper section may be removed to allow a front wheel of a towed bicycle to be placed in the cradle and then inserted and lowered into posts 46a′ to lock the wheel in place.

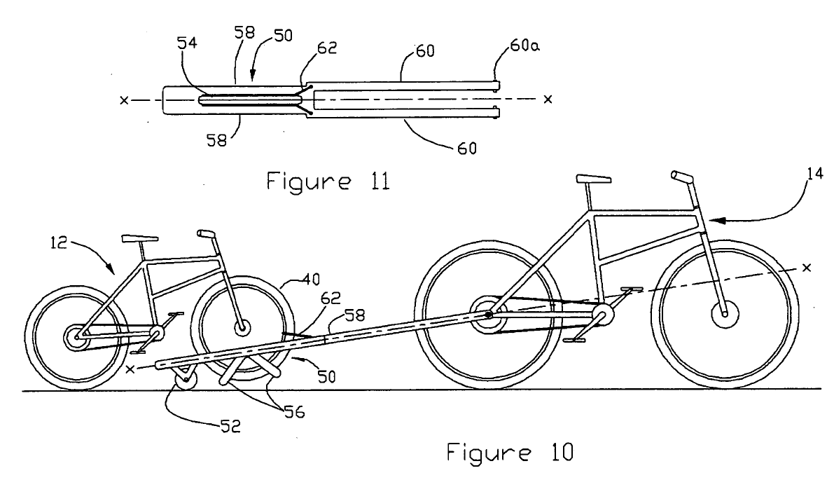

An alternative embodiment of the trailer is shown in FIGS. 10 and 11 in which a frame 50 supports a front wheel of a towed bicycle via a single wheel 52. The frame defines a front wheel of a towed bicycle receiving opening 54 which is spanned by a pair of u-shaped wheel engaging members 56 extending downwardly from side support members 58 and define a cradle or a wheel well for supporting the lower portion of the front wheel of a towed bicycle as is illustrated in FIG. 10. A tow bar in the form of parallel bars 60 extends forwardly with a connection system 60a which may be in the form of a clamp or bracket (not shown). A cable 62 having one end fixedly attached and the other end removably attached to the frame adjacent the front of the front wheel of a towed bicycle may be looped through the spokes (not shown) of the wheel to lock a front wheel of a towed bicycle in place.

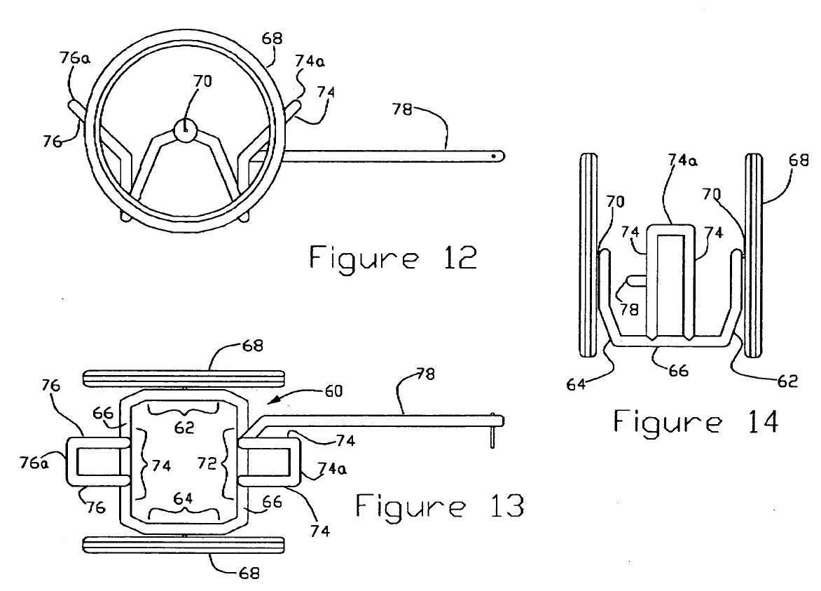

Referring now to FIGS. 12-14 an alternative trailer arrangement includes a frame 60 formed by curved side members 62 and 64 which are joined together at their lower ends by horizontal pieces 66. Wheels 68 are mounted at the apex of the members 62 and 64 via axles 70 as shown. The central sections 72 of the horizontal pieces 66 are arranged to engage the lower portions of the front wheel of a towed bicycle and along with upwardly extending parallel arms 74 and 76 form a cradle to secure the front wheel of a towed bicycle within the frame. As is shown, the arms extend generally upwardly from the central sections 72, then outwardly and are joined by cross bars 74a and 76a, as shown.

In operation the trailer is connected to the towing bicycle, e.g., to the frame adjacent the rear axle, at the beginning of the ride. When the child tires, his or her bicycle may be secured in the trailer by simply placing the front wheel of the bicycle in the cradle or wheel well and preferably secured therein by means of stabilized locking bracket or cable. The ride may then continue without requiring any further peddling or steering effort on behalf of the child. If the child later wants to ride, the child's bicycle can simply be removed and the trailer can be towed empty. While the term “child” has been used herein to designate a second cyclist, it is to be noted that the second rider can be an adult. It should also be noted that the trailer can be widened to accommodate multiple cradles or wheel wells. It should also be noted that while the preferred embodiments are directed to a bicycle, other wheeled vehicles may be accommodated by the trailer.

There has thus been described a simple and relatively inexpensive towing trailer which does not require any modification of the towed bicycle and allows the front wheel of the towed bicycle (or other vehicle) to be inserted into the trailer with a minimum effort. Various modifications or improvements will occur to those skilled in the art without involving any departure from the spirit and scope of my invention as spelled out in the appended claims.

What is claimed is:

1. A bicycle trailer for supporting the front wheel of a towed bicycle behind a towing bicycle along a support surface comprising:
at least one wheel; and
a frame supported at least in part by said at least wheel and defining a longitudinal axis x-x and a cradle for receiving and supporting the front wheel of the towed bicycle above the support surface, the frame having a tow bar extending forwardly of the cradle for connection to the towing bicycle.

2. The trailer of claim 1 wherein the cradle includes a wheel support structure for engaging the towed bicycle's front wheel at a plurality of locations.

3. The trailer of claim 2 wherein the wheel support structure includes at least two wheel engaging members spaced along the longitudinal axis for engaging the towed bicycle's front wheel below the axle of the front wheel of the towed bicycle.

4. The trailer of claim 3 wherein said at least two wheel engaging members are generally u-shaped.

5. The trailer of claim 3 wherein said at least one wheel comprises two wheels disposed on opposite sides of the cradle.

6. The trailer of claim 5 wherein the frame further defines a pair of side support members disposed between the cradle and the trailer wheels.

7. The trailer of claim 6 wherein the side support members have axles mounted thereon for rotatably supporting the trailer wheels, the axles being aligned along an axis y-y perpendicularly oriented with respect to the longitudinal axis.

8. The trailer of claim 7 wherein the frame further includes stop members for engaging the towed bicycle's front wheel to substantially maintain the front wheel of a towed bicycle within the cradle during the towing operation.

9. The trailer of claim 7 wherein the frame further includes a pair of stabilizer posts on opposite sides of the front wheel of a towed bicycle for engaging the towed bicycles front wheel to substantially maintain the towed bicycle in a vertical plane during the towing operation.

10. The trailer of claim 9 wherein the stabilizer posts include a cross bar extending across the top of the posts.

11. The trailer of claim 10 wherein the stabilizer posts are vertically adjustable.

12. The trailer of claim 10 wherein at least an upper portion of the stabilizer posts are arranged to pivot about an axis parallel to the y-y axis.

13. The trailer of claim 3 wherein said at least one wheel is a single wheel positioned adjacent the rear portion of the cradle.

14. The trailer of claim 4 wherein the frame includes a pair of side support members, the generally u-shaped wheel engaging members extending downwardly from the side support members and wherein the tow bar comprises two opposed bars extending forwardly from the side support members for attachment to opposite sides of a towing bicycle frame.

15. A bicycle trailer for supporting the front wheel of a towed bicycle behind a towing bicycle along the ground comprising:
a pair of wheels; and
a frame defining a longitudinal axis and having opposing side sections to which the wheels are rotatably mounted, the frame defining an interior opening for accommodating the front wheel of the towed bicycle, with a wheel support structure spanning at least a portion of the interior opening for engaging and supporting the lower portion of said front wheel above the ground, the frame having a forwardly extending tow bar adapted to be connected to the towing bicycle.

16. The trailer of claim 15 wherein the frame further includes stop sections spaced along the longitudinal axis and arranged to engage portions of the towed bicycle's front wheel to inhibit forward and backward movement of the towed bicycle relative to the trailer while being towed.

17. The trailer of claim 15 wherein the frame further includes a pair of stabilizer posts extending upwardly on opposite sides of a towed bicycle's front wheel to laterally stabilize the towed bicycle during a towing operation.

18. A trailer for supporting the front wheel of a towed vehicle behind a wheeled vehicle traveling along the ground comprising:
a frame defining a longitudinal axis x-x and having opposing side sections and a generally channel shaped center section forming an elongated opening for receiving the front wheel of a towed vehicle, the center section forming a wheel well for supporting the bottom portion of the front wheel of a towed bicycle; and
a wheel rotatably mounted on each side section for supporting the wheel well and a towed bicycle's wheel supported thereby above the ground.

19. The trailer of claim 18 wherein the wheel support structure includes at least one generally u-shaped wheel engaging member.
